(19) United States
(12) Patent Application Publication
(10) Pub. No.: US 2019/0213914 A1
(43) Pub. Date: Jul. 11, 2019

(54) KITCHEN PERSONAL ASSISTANT

(71) Applicant: Sandra Vallance, Belair (AU)

(72) Inventor: Sandra Vallance, Belair (AU)

(21) Appl. No.: 15/911,235

(22) Filed: Mar. 5, 2018

Related U.S. Application Data
(60) Provisional application No. 62/466,390, filed on Mar. 3, 2017.

(51) Int. Cl. G09B 19/00; H04L 12/28; G06Q 30/06; H04W 4/35; G06N 20/00; G06Q 30/02

(52) U.S. Cl. CPC G09B 19/0092; H04L 12/2827; G06Q 30/0201; H04W 4/35; G06N 20/00; G06Q 30/0633

(57) ABSTRACT

The present invention is generally related to a menu and food management planning system system for creating a personal assistant that brings together recipes, weekly requirements, current stocks of food items and household preferences. The system may be implemented using a range of technologies in the kitchen including machine learning, predictive analytics, optical character recognition, APIs (Application Programming Interfaces), bar code scanning, web server and app technologies. A client using the app will be able to determine and source their menu and food management requirements for their selected period which may be a combination of their own recipes from existing recipe sources. Integration with online and brick and mortar shopping may be provided.

### PRIORITY CLAIM

This application claims priority to U.S. Patent application No. 62/466,390, filed Mar. 3, 2017 and titled, “KITCHEN PERSONAL ASSISTANT,” the contents of which is incorporated by reference in its entirety.

### BACKGROUND

Many home cooks and professionals have a substantial collection of cookbooks. Online sources of recipes have exploded in recent years with access now available to millions of recipes online.

Despite the breadth of choices available, many cooks rely on only a handful of recipes from a few sources. Many write on their cookbooks in order to know which ones they have tried and how they were received. It can be difficult to remember which recipes are in which cookbooks, and also to remember what recipes have been prepared for whom.

Being a little time poor, putting together a menu for the week in order to have a shopping list for the weekly shop needs to be a quick affair. While I would love to have the time to flick through my library of cookbooks I don't. I have tried a number of techniques to get around this, but they leave me unsatisfied. I look at my cookbooks and think I am not getting a return on my investment in them due to time constraints. They contain great recipes but I haven't time to trawl. This is very frustrating. Talking to friends as well, they also feel the pressure and grind associated with putting together a menu every week for their household.

Now there are a lot of recipe management tools out there but unfortunately, I am not one of those people with the time to type out my recipes. I forget, it strikes me as being highly inefficient and while I am sure I would love it, it's not going to happen.

What is thus needed is a system with the ability to:
a) remotely or locally store recipes in a digital format;
b) rate these to remind me of the household's perception of the meal;
c) tag recipes with a range of characteristics (e.g., happy to eat once a month, what days you like to eat this recipe, great for brunch, great for big group, great for if you want something fast, slow cooker, etc.);
d) automatically determine if the meal is lactose free, fructose free, gluten free, nut free, etc;
e) indicate for your family and friends any special requirements around allergies or food that they do and don't like to eat;
f) create a weekly menu where I can specify what characteristics I am seeking from each of the meal;
g) generate a shopping list based on the menu, which can be available on a smartphone or tablet, or automatically linked to online supermarket shopping;
h) suggest when I should start cooking and assist with elements of the cooking process (e.g., timers);
i) enable reviews via social media by my guests;
j) see what I had cooked for whom and when (and decide whether sufficient time had passed for me to cook the same meal again for them)
k) make suggestions of what to try in your cookbooks based on other people's experience of the same cookbook and the similarity of their ratings to yours;
l) make suggestions of what to try on in linked Internet recipe sites based on other people's experience with the same recipes as you and the similarity of their ratings to yours;
m) make suggestions based on pantry items I have bought and use them before they expire;
n) provide shopping lists based on my preferences, both for online shopping a brick and mortar stores;
o) help me save money on my shopping list;
p) help me use items that I have planted in the garden;
q) help me use items in my refrigerator or pantry;
r) provide advice on a household diet;
s) view, using de-identified data, data showing a range of trends on what people are eating and how often;
t) provide information for cookbook publishers/authors on what recipes their students are using and how often;
u) promote new cookbooks to known cookbook purchasers;
v) enable paid sharing of recipes; and
w) understand what we eat and how it impacts our health.

### BRIEF DESCRIPTION OF THE DRAWINGS

The features and advantages of the present disclosure will be more fully understood with reference to the following detailed description when taken in conjunction with the accompanying figures, wherein:

FIGS. 1a-1d show a high level system view of an exemplary embodiment of the invention;

FIG. 2. is a high level system diagram of a MyRecipes application and data storage unit according to embodiments of the invention;

FIG. 3 is a high level system diagram of a MenuPlanner application and data storage unit according to embodiments of the invention;

FIG. 4 is a high level system diagram of the Shopping application and data storage unit according to embodiments of the invention;

FIG. 5 is a high level system diagram of the RecipeUsed application unit according to embodiments of the invention;

FIG. 6 is a high level system diagram of the HealthAnalytics application and data storage unit according to embodiments of the invention; and

FIG. 7 is a high level system diagram of the AccountManagement application and data storage unit according to embodiments of the invention.

### DETAILED DESCRIPTION

In embodiments of the invention, a system known as the Kitchen PA system, comprises six primary units; MyRecipes storage database and application unit; MenuPlanner application and data storage unit; Shopping application and data storage unit; RecipesUsed application unit, HealthAnalytics application and data storage unit and the AccountManagement application and data storage unit. All the units mat be hosted on extensible cloud infrastructure (i.e., Amazon web Services, Google Cloud or Microsoft Azure). The client will interface with the six primary units using an app on their preferred smart phone or tablet device or via a web site.

MyRecipes is the repository of recipes in machine readable form. Each recipe has the following minimum information: (1) Recipe name (e.g., Curried apple and Sweet Potato Soup); (2) Source meta data information (e.g., owned cookbook, magazine, online source, self); (3) if an owned cookbook, additional information is collected (author, cookbook name, page number of recipe); (4) Serving size; (5) Ingredients which are broken down by quantity, unit, ingredient, preparation associated with ingredient if specified (e.g., 1 large carrot grated); and (6) Method. Additional information that can be stored includes: (1) Time to prepare; (2) Time to cook; (3) Comments; (4) Rating of the recipe; (5) Indication of how frequently the household would like to eat this recipe; (6) what days the household likes to eat this recipe, (7) indicate if leftovers are good for school lunches; (8) indicate if good for a group; (9) preferred season to eat; (10) picture of recipe; and (11) link to a video of how to make the recipe. Additional meta data will be created by analytics and machine learning for the recipe such as allergy information (e.g., gluten free, nut free, egg free, lactose free, fructose free), nutritional information, type of cooking (e.g., slow cooker). For each of the ingredients additional metadata will also be collected (i.e., vegetable, fruit, protein, seafood, fructose, nut, lactose, fructose) via API with database such as Open Food Facts or Spoonacular.

There are 5 input methods to MyRecipes; OCR input method, Print input method, Email input method, API Recipe

input method from online sources and manual method. A fifth input method would be explored of API Recipe input method from Cookbook Publishers combined with secure payments processing.

The MyRecipes OCR input method utilizes the technologies of high quality photography, Optical Character Recognition (OCR) and Machine Learning to create the fastest and most time efficient to capture recipes in the MyRecipes from owned cookbooks and magazines. The client will be guided through taking a single photograph of the recipe which can then be magnified or multiple photographs of a recipe on their preferred smart phone or tablet device. OCR will be used to convert the photo into text and images. The OCR is calibrated to deal with low quality and shaded photographs. Machine Learning will analyze the text and learn how to automatically convert the data into minimum and additional recipe information outlined above.

The Print Recipe input method combined with Machine Learning to convert printed documents to recipe components from online sources where no API exists.

The Email Recipe input method combined with Machine Learning converts email contents to recipe components. The API Recipe input method from online sources utilizes the technologies associated with application Programming Interfaces such as Yummly API, Spoonacular API, BigOven API, Pinterest API and Instagram API to efficiently gather minimum and additional recipe information.

The manual method allows the manual entry of minimum recipe and additional recipe related information using an app on their preferred device or via a web site.

A Search function with filters is available to search for recipes. If changes are to be applied to a recipe, the manual method is available to make these changes (e.g., convert a recipe with gluten to gluten free by modifying ingredients).

The MenuPlanner application Unit is available for free for the first 6 months and then there is a monthly subscription to continue to access this feature supported by secure payments processing. This application Unit is designed to create convenience for the client. The client will interface with the MenuPlanner app on their preferred smart phone or tablet device or via a web site. When a client first uses the MenuPlanner, the client will be asked to set up a profile of what to generally consider in menu planning (e.g., mixture of proteins, make one night a week vegetarian, make one night a week seafood, just plan for evening meals, what time they typically like to eat breakfast, lunch and dinner). Other profile information will be created for the client such as do they grow ingredients in the garden, do they want to use ingredients already in the pantry?

Other optional preference options the client can set include preferred Kit meal suppliers (e.g., Home Chef, Blue Apron), Home meal delivery (e.g., Munchery, UberEats), takeaway or book a café/restaurant (e.g., OpenTable). Suppliers of these services will be encouraged to advertise their services. Using APIs, the Menu Planner can link to these suppliers with the client's credentials.

When the client selects the MenuPlanner, they will be asked if they wish to vary any of their preferences. The client will then be asked if there are any specific circumstances to use in the next period's planning (e.g., specify a date as a dinner party with certain guests, use specific ingredients, planning for additional or different meals e.g., breakfast or lunch on certain days, if they would like to be surprised by a recipe they haven't used in more than 6 months, what is ripe in the garden, planning to go out for a certain meal, prefer to use a service for a certain meal service). Using geolocation on the client's device, the app will determine what the weather forecast is for the menu period and include seasonal considerations into the menu analytics. Analytics will predict combinations of menus for the client.

If cooking for a dinner party with friends, calendar invites can be sent to these friends. Friends can connect via Facebook API. Friends indicate any food allergies which will be stored for future reference. Analytics then occurs on the MyRecipes database to identify a menu for the period required. The Analytics application module will include nominated preferences and identify recipes that match criteria based on requested frequency to eat, ratings from household and any food intolerances in the household or people attending a meal. The menu for the period will be presented to the client. By day, the client can accept the recommended recipe(s), ask for another suggestion (but still return to and accept the original suggested recipe), or reject the suggestion and have another presented. Once days in the selected menu period are accepted, the menu for the period is available on the client's app and/or via the web site. It can also be printed out to put on the refrigerator.

The completed menu will then populate a shopping list. As part of setting up their initial, preferences the client is asked to indicate their preferred online and brick and mortar grocery stores. When presented with the initial shopping list, the client will have the option to add or remove items from the shopping list. Paid advertising related to shopping list items, food, cooking, cook books, kitchen accoutrements will be supported. Once the shopping list is complete, the client will be asked if they wish to shop at a specific store or whether they wish to have the cheapest option presented based on the items on the list. For those items to be purchased online, those items will be transferred to the online grocery store via an API for purchasing and delivery. The Shopping List for brick and mortar shopping will be available on the app or can be printed out.

For food that is purchased in store, it can be ticked off the shopping list on the app or bar code scanned post purchase. Pantry items will be updated and either the actual or an estimated use by date will be applied. Food purchased online can similarly update the Pantry database. The client has a manual interface to modify the Pantry database.

For those meals, where the client has indicated they plan not to cook themselves, the client will be provided options to link to preferred options via an API. For these meals, the client will be transferred to the preferred service provider's app/web site with credentials.

Each meal on the menu planner will be added to the client's preferred calendar tool and personal assistant (e.g., Cortana/Siri/Google/Amazon) via embedding or API. Working with the preferred Personal Assistant, the client will be advised when to commence cooking dependent on preferred eat time, where to find the recipe (e.g., if in a cookbook) or display the recipe on the preferred app or web site. Working with the Personal Assistant, the client will be supported through the recipe using voice.

After the meal, the client will be asked if they made/consumed the meal, how they would rate the meal, and to change any preferences around the meal or if they want to update the recipe using the RecipesUsed application Unit. MyRecipes will be updated with date cooked, any preference changes and recipe changes. If the meal was cooked for friends, they will also have the opportunity to rate the meal and ask for the recipe.

MyRecipes provides information on what ingredients have been eaten in estimated proportions and when. APIs with food databases (e.g., Ingredients API—http://world.openfoodfacts.org/ and Spoonacular) provide nutritional information on ingredients. HealthAnalytics can now be used to provide information on the quality of diet based on a range of health metrics (e.g., calorie intake, salt, sugar, diversity of diet, etc.) and then the client will be provided a choice to indicate if they would like to make adjustments to their diet over time (e.g., increase diversity, reduce sugar, reduce carbohydrates, increase protein) on the HealthAnalytics app. HealthAnalytics will be provided for free for 6 months if the client is using MenuPlanner. After six months, it will be available as a subscription service. There is potential to link feedback to client preferred Fitbit, apple Health, Microsoft Health or other Health apps using APIs.

With consent from the client, this information could also be made available to Health insurance providers for a fee, providing important information to Health insurance organizations on eating habits of their clients. This would provide the opportunity to identify and reward lower risk clients.

At a macro level, information can be de-identified but available for a fee to indicate eating habits based on a variety of demographics and socio-economic criteria.

The client has access to their Account information which will include access to seeing all recipes purchased and subscriptions paid. It also includes access to menus for periods created, benefits realization statistics on time saved and money saved shopping.

In embodiments, the following specific data storage items are capitalized:

a) Recipe

b) Recipe Metadata

c) Ingredient

d) Ingredient Details

e) Method

f) Additional client Specified Recipe Information

g) Machine Learnt Recipe Information

h) General Menu Planning Preferences

i) This Menu Period Preferences

j) Extended Family and Friends

k) Household Members

l) Outsourced Meal Preferences

m) Period Menu

n) Pantry Items

o) Garden Items

p) Menu Ingredients

q) Regular Shopping List Additions

r) Grocery Store Preferences

s) Period Shopping List

t) Shopping List Alternatives

u) Store Specific Period Shopping Lists

v) Client Account

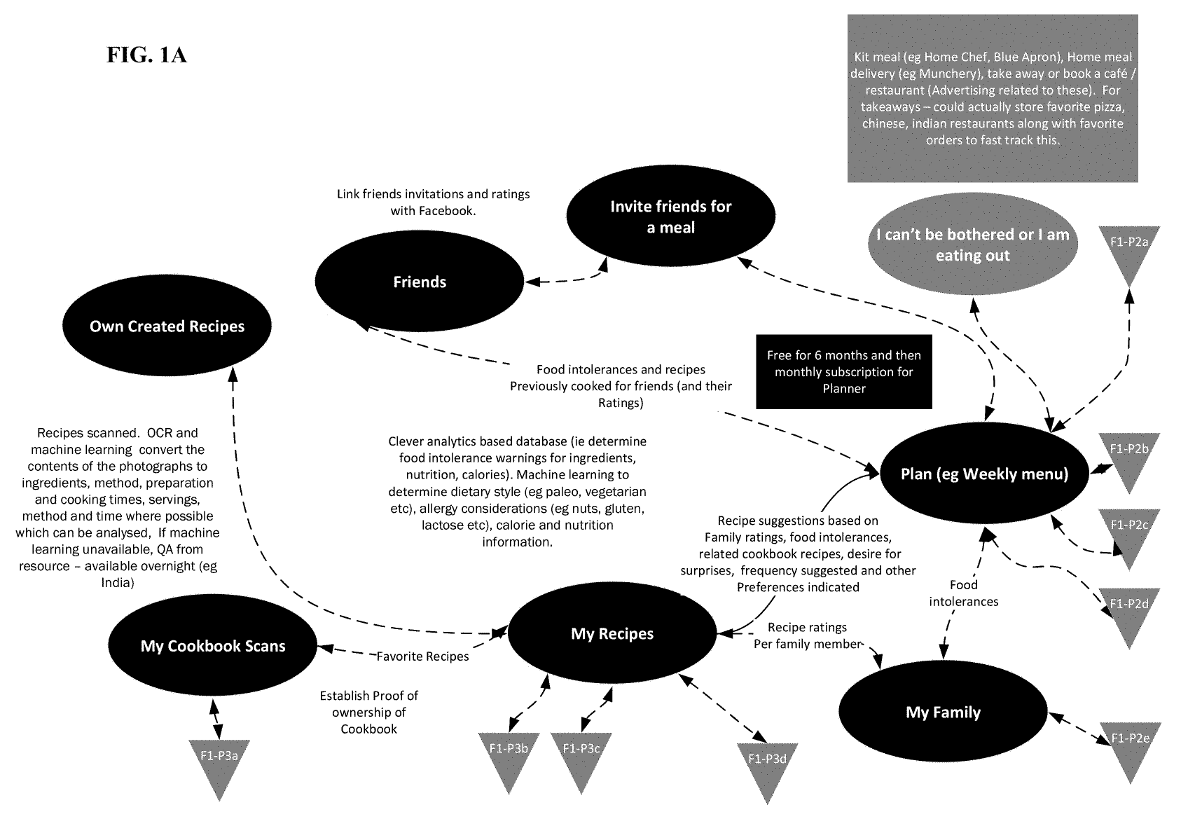

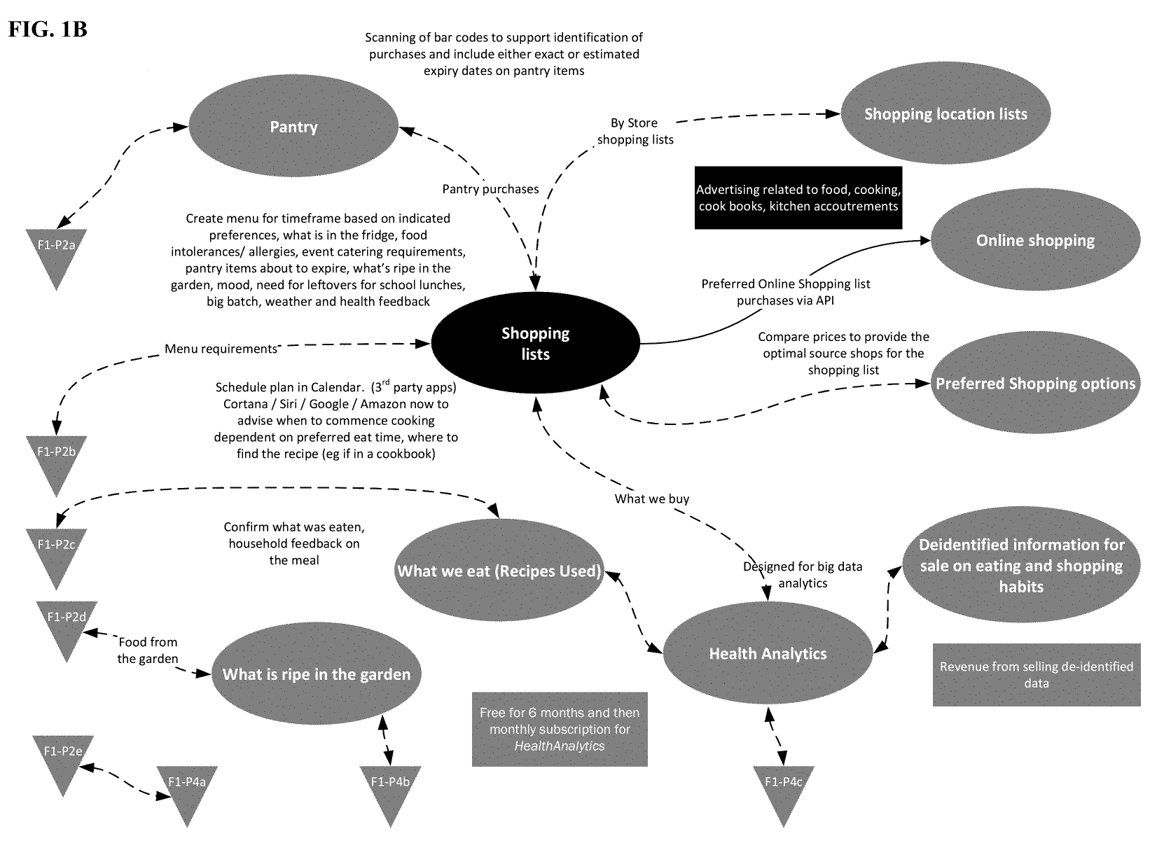

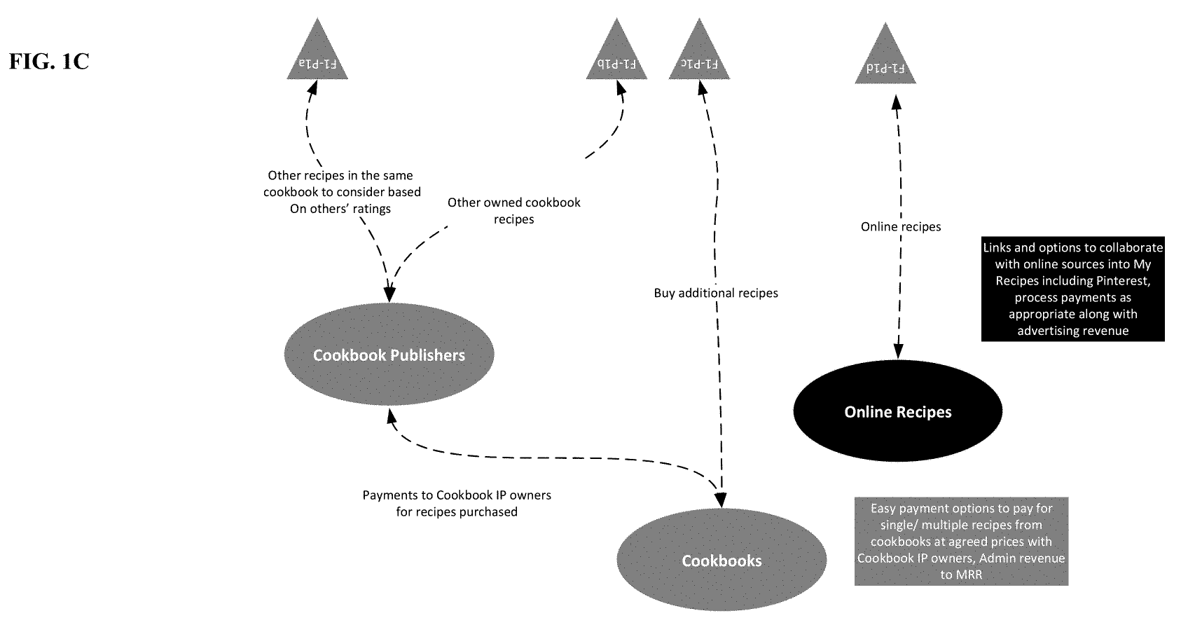

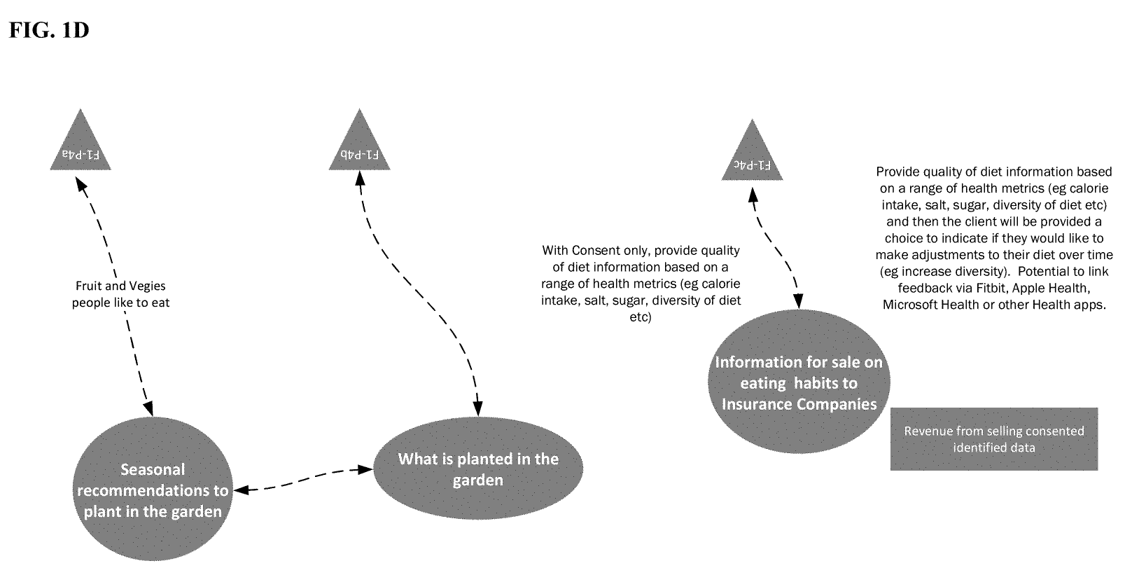

Machine learning is central to the MyRecipes application unit depicted in FIGS. 1a-1d. All recipes regardless of input method are fed through the machine learning process to split recipes into 6 types of data:

First, Recipe Metadata may include source (e.g., owned cookbook, magazine, online source, self); if an owned cookbook, additional information is collected (author, cookbook name, page number of recipe); serving size; time to prepare; time to cook; type of cooking (e.g., slow cooker).

Ingredient Details may be broken down by quantity, unit, ingredient (stored as a unique entity), preparation associated with ingredient if specified (e.g., 1 large carrot grated).

Ingredients may be input to the machine learning subsystem.

The Method may be input to the machine learning subsystem.

Additional information may include including client comments; rating of the recipe; indication of how frequently the household would like to eat this recipe; indicate if leftovers are good for school lunches; indicate if good for a group; preferred season to eat; picture of recipe; link to a video of how to make the recipe.

Lastly, additional metadata will be created by analytics and machine learning for each Ingredient such as allergy information (e.g., gluten free, nut free, egg free, lactose free, learned from linking to additional metadata about ingredients which is collected (i.e., vegetable, fruit, protein, seafood, fructose, nut, lactose, fructose) via API with database such as Open Food Facts or Spoonacular.

In embodiments, 5 recipe input methods may be provided. Unique is the MyRecipes OCR input method. This method involves the client photographing the recipe into readable sections. The client has the choice of taking the photographs in the app or uploading existing photos. Once uploaded, the photograph(s) are put through the Optical Character Recognition (OCR) process. The OCR process turns the images into letters, numbers, symbols and photos. The output of the OCR process and then feed to the MyRecipes machine learning process to split the recipe into the 6 types of data outlined above.

The Print Recipe and Email Recipe input methods combined with Machine Learning to split the recipe into the 6 types of data outlined above.

The API Recipe input method from online sources utilizes the technologies associated with application Programming Interfaces such as Yummly API, Spoonacular API, BigOven API, Pinterest API and Instagram API to efficiently gather minimum and additional recipe information from current online sources and then feed to the MyRecipes machine learning process to split the recipe into the 6 types of data outlined above. To access recipes via this method the client needs to copy a link of the page of the recipe into adding an Online Recipe. This link will be then matched with the appropriate API to source the recipe. If it cannot be sourced, the client will be advised via the Kitchen PA system. In time, as the Kitchen PA system becomes popular, a share to Kitchen PA button would be available on sites which hold recipes to easily add recipes to MyRecipes.

The manual method allows the manual entry of minimum recipe and additional recipe related information using an app on their preferred device or via a web site. Once again this method feeds the MyRecipes machine learning process to split the recipe into the 6 types of data outlined above.

A sixth input method would be explored of API Recipe input method from Cookbook Publishers combined with secure payments processing.

The recipes in MyRecipes are used by the multiple processes within the MenuPlanner application unit. Recipes are updated when recipes are used by the client by the RecipesUsed application unit.

The final important element of the MyRecipes application unit is the ability to search for Recipes. The client can recipes using Search function with filters. The client is provided with the option to manually update the recipe. If changes are to be applied to a recipe, the manual method is available to make these changes (e.g., convert a recipe with gluten to gluten free by modifying ingredients).

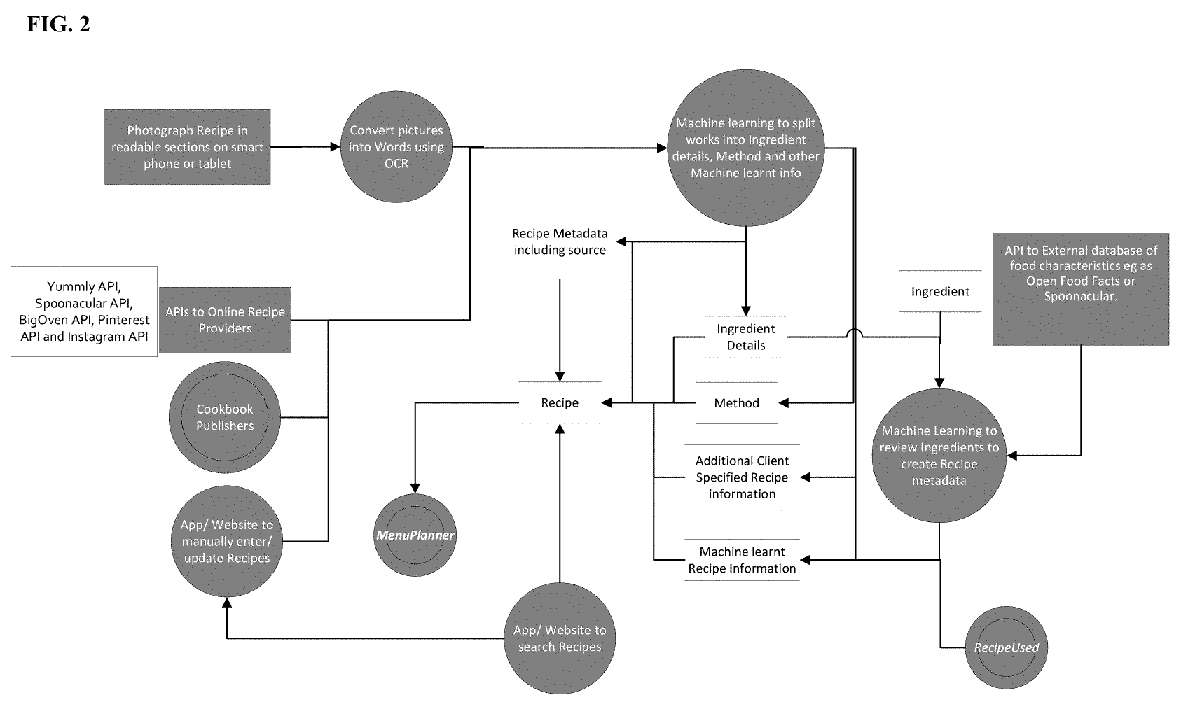

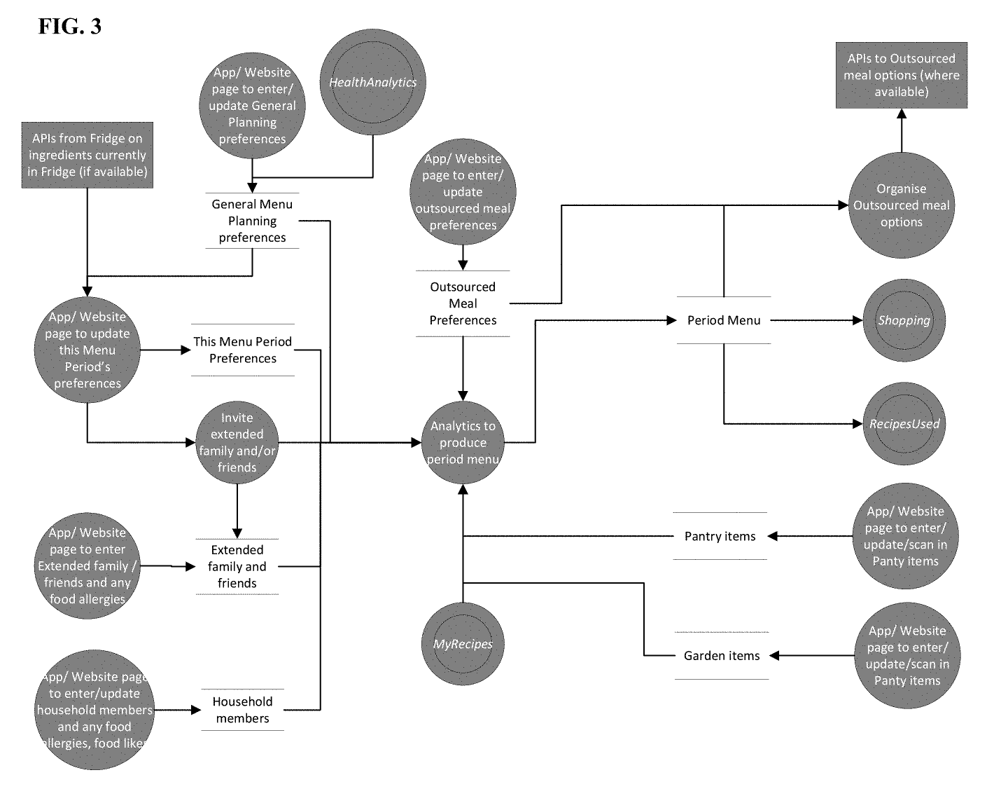

The MenuPlanner depicted in FIG. 2 relies on Analytics technology to use a range of extensive range of inputs to create a menu for the period the client has preferred. On initial set up, the client establishes their general planning preferences including what period to plan menu for, like leftovers for school lunches Monday-Friday, eat out on Thursday nights, like a mixture of proteins, make one night a week vegetarian, make one night a week seafood, just plan for evening meals, what time they typically like to eat breakfast, lunch and dinner. This information is entered and updated using an app or website page.

On initial setup, the client establishes information about household members, food allergies and particularly food likes using an app or website page. This information can also be updated.

When planning a menu, the client is asked if they wish to vary any preferences for this period, for example, specify a date as a dinner party with certain guests, use specific ingredients, planning for additional or different meals e.g., breakfast or lunch on certain days, if they would like to be surprised by a recipe they haven't used in more than 6 months, what is ripe in the garden, planning to go out for a certain meal, prefer to use a specific provider for a certain meal service. The client can also indicate if there are ingredients in the Pantry they would specifically like used, or if they would like to consider Pantry Items where expiry might be coming due. If the client has a refrigerator which detects and monitors the ingredients in it, then an API from this refrigerator can update the list of available ingredients in the refrigerator that the client may wish to consider in their menu.

If cooking for a dinner party with extended family/friends, calendar invites can be sent to these extended family/friends via email or as a Facebook event using the Facebook API. Extended Family/Friends indicate any food allergies which will be stored for future reference as well as rate the meal and exchange messages. Alternatively, the client can use an app or website page to update any food allergies for extended family/friends.

Using an app or website page, the client can also set Outsourced meal preferences including preferred Kit meal suppliers (e.g., Home Chef, Blue Apron), Home meal delivery (e.g., Munchery), UberEats, take away or book a café/restaurant (e.g., OpenTable). Suppliers of these services will be encouraged to advertise their services.

Using preference information, Analytics then occurs on the MyRecipes database to identify a menu for the period required. The Analytics application module will include nominated preferences and identify recipes that match criteria based on requested frequency to eat, ratings from household and any food intolerances in the household or people attending a meal. The menu for the period will be presented to the client. By day, the client can tick to accept the recommended recipe(s), ask for another suggestion (but still return to the tick and accept the original suggested recipe), or reject the suggestion and have another presented. Once days in the selected menu period are accepted, the Menu for the period is available on the client's app and/or via the web site. It can also be printed out to put on the refrigerator (a relatively common practice). If the Period Menu includes outsourced options, using APIs, the MenuPlanner can link to these suppliers with the client's credentials.

The Period Menu also available with its ingredients to feed the Shopping Application Unit.

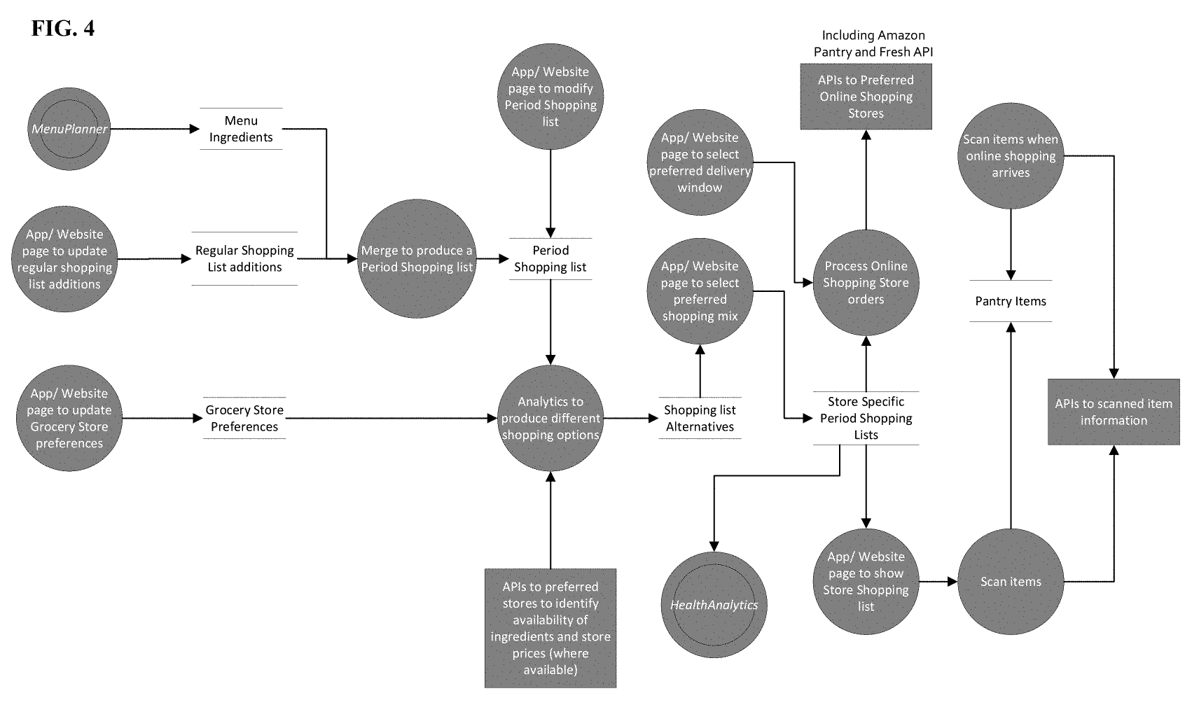

The Shopping Application Unit is depicted in FIG. 4. Along with the Menu ingredients identified by the MenuPlanner application Unit, the client can maintain a regular list of Shopping List additions for the period shopping (e.g., bananas, milk, coffee) using an app or website page. These are merged to create a Period Shopping List. The client can modify the proposed Period Shopping list using an app or website page.

Using an app or website, the client can also set Grocery Store preferences including preferred online grocery shopping options and preferred brick and mortar shopping locations. The client can also set which preferred Grocery Store option for which ingredients or ingredient group (e.g., Costco for meat, Whole Foods for fruit and vegetables). Grocery stores and other related kitchen/cooking purveyors of goods and services will be encouraged to advertise their products and services.

Analytics is then used to bring together the Period Shopping list and Grocery Store preferences, along with data from the Grocery Stores (via APIs) to determine the Shopping list alternatives (i.e., cheapest place(s) to undertake this Periods shopping, cost of doing all of the shopping at each of the preferred Grocery Stores). Using an app or website, the client selects which Shopping List Alternative they wish to use for this period which then create Store Specific Shopping Lists. For the Online Store Specific Shopping Lists, these will be processed using the client's account information and the client indicating their preferred delivery window via an app or website page. The online order is then processed via an API with the online grocery store.

Brick and mortar shopping lists are available on an app page or can be printed out. The client can tick off items from the brick and mortar shopping lists as the select items while shopping. Items that will go into the Pantry can be scanned so that expiry dates can then be estimated on items (or can be specifically entered by the client).

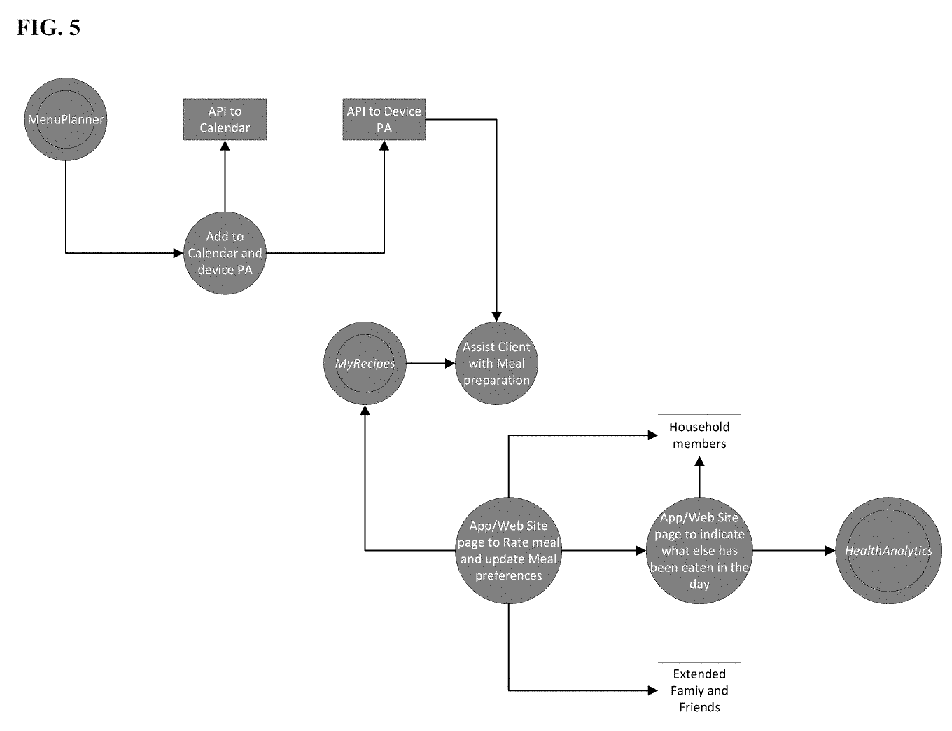

Each meal from the MenuPlanner will be added to the client's preferred Calendar tool and Personal Assistant (e.g., Cortana/Siri/Google/Alexa) via API in the RecipesUsed application unit illustrated in FIG. 5. Working with the preferred Personal Assistant, the client will be advised when to commence cooking dependent on preferred eat time, where to find the recipe (e.g., if in a cookbook) or display the recipe on the preferred app or web site. Working with the Personal Assistant, the client will be supported through the cooking of recipe with the use of timers and suggestions on when to start the next process.

After the meal, the client will be asked if they made/consumed the meal on an app or web site page, how they would rate the meal, and to change any preferences around the meal or if they want to update the recipe. The client and householder will also be asked if they would like to indicate other food consumed for the day. This information will be made available to the HealthAnalytics application unit. MyRecipes will be updated with date cooked, any preference changes and recipe changes. If the meal was cooked for friends, they will also have the opportunity to rate the meal and ask for the recipe via email or Facebook and linking to a web site page.

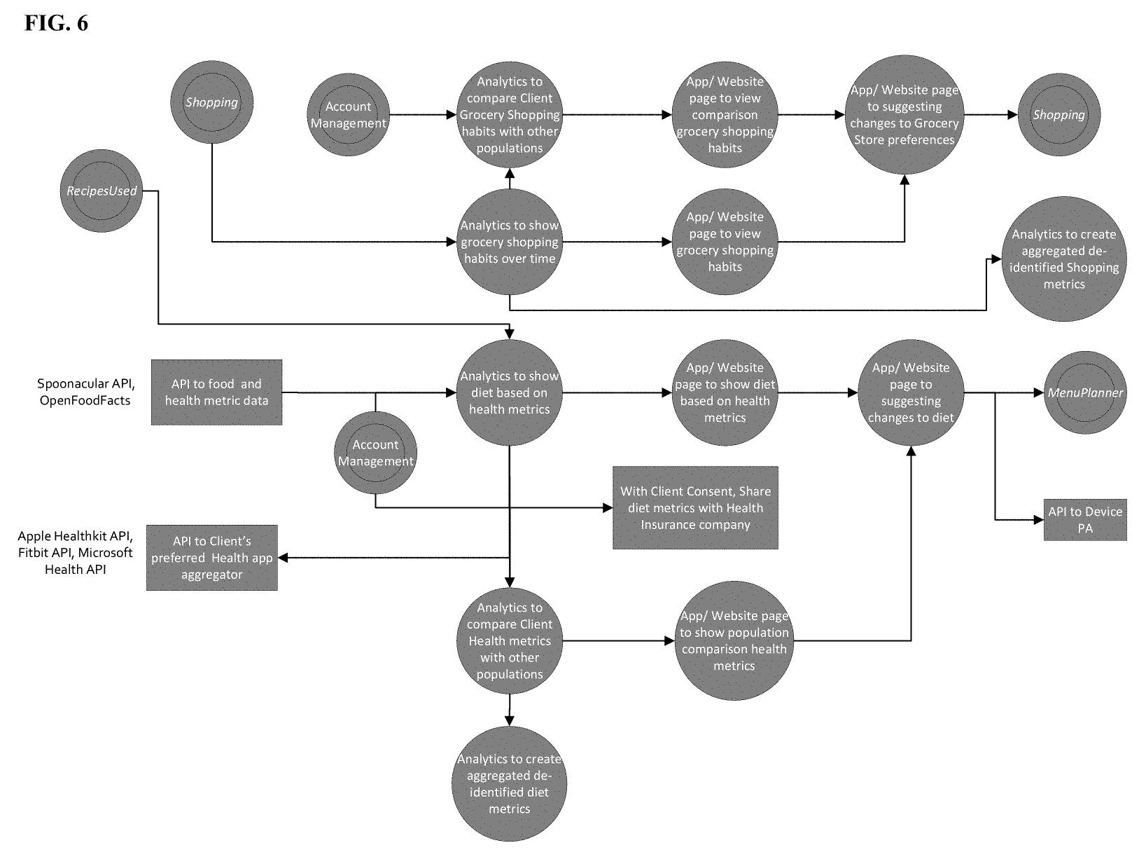

FIG. 6 depicts the HealthAnalytics application unit. There are 2 parts to this, analytics of grocery shopping and analytics of diet. In the Grocery Shopping List analytics a range of data sourced from the Shopping application unit is analyzed and presented based on products purchased, where shopping has occurred, savings taken advantage of, percentage of online shopping vs brick and mortar shopping. This information will be shared with the client on an app or website page. Based on demographics and socioeconomic details based in client AccountManagement, grocery shopping habits can be compared with other selected demographics and socioeconomic populations. This information will be shared with the client on an app or website page. Based on the findings of the Analytics, the client can be presented with suggested changes to the Grocery Store preferences. If those changes are accepted, the changes will update the Grocery Store preferences in the Shopping application unit.

Food and associated health information by ingredients is stored in databases such as Spoonacular and OpenFoodFacts. Using APIs to these databases and the data stored in MyRecipes, Analytics will be applied to show the diet of the client and householders based on what they have been eating and compared with health metrics (e.g., calorie intake, salt, sugar, diversity of diet, etc.). This information will be presented to the client via an app or web site page. In addition, the client can view Analytics comparing their diet metrics with other demographic populations. The client will be provided with suggested changes to diet over time via an app or web site page (e.g., increase diversity). If changes are accepted, these will update the MenuPlanner. Suggestions can also be passed to the client's device suggesting to eat fruit as a snack during the day.

The HealthAnalytics application Unit is available for free for the first 6 months and if the client is using the MenuPlanner and then there is a monthly subscription to continue to access this feature supported by secure payments processing.

In AccountManagement, clients will update what populations they are compared with in the HealthAnalytics application Unit. If there is an interest from Health Insurance companies to have access to a client's HealthAnalytics information, the client will be able to indicate in AccountManagement whether they are willing to share that information. There would be a fee to share this information with a Health Insurance company.

Finally, Analytics can be used to create a de-identified dataset of diet metrics associated with demographics and socio-economic factors which can be sold to organizations for a fee. Similar Analytics can be used to create a de-identified dataset of shopping metrics associated with demographics and socio-economic factors which can be sold to organizations for a fee.

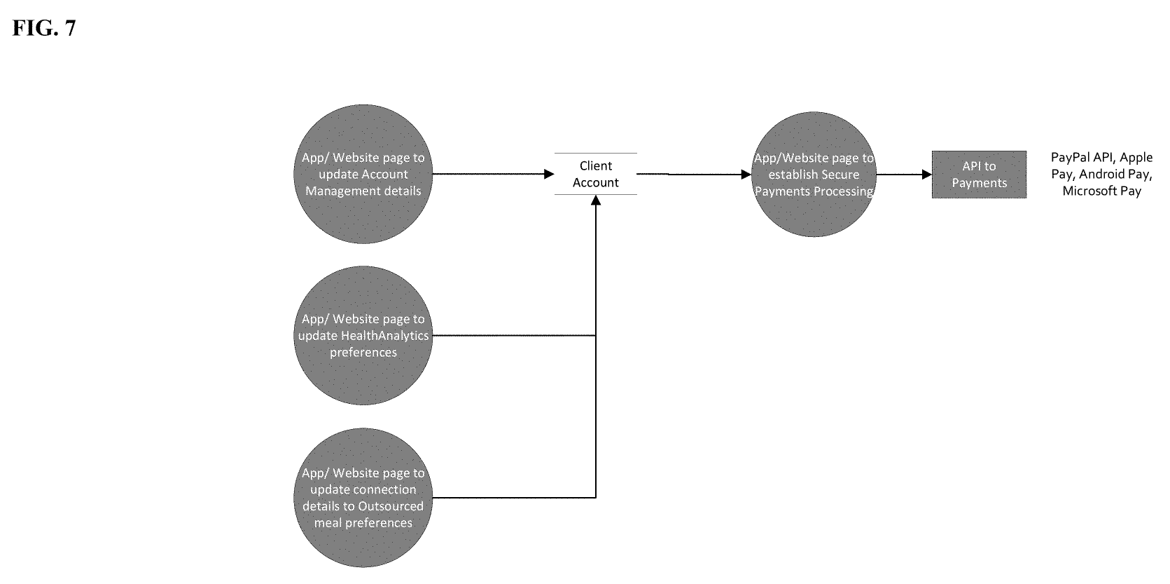

FIG. 7 depicts AccountManagement. The client will be able to manage their details on an app or web site page including if they wish to opt out of the MenuPlanner and HealthAnalytics application Units after 6 months. The client will establish their preferred payment method using an app or web site page. APIs will be used to link to the popular payment methods (e.g., PayPal, apple Pay, Android Pay, Microsoft Pay, preferred secure credit card processing). Once the 6 months since participation has commenced is past and if the client has opted into the MenuPlanner and HealthAnalytics application Units or only the MenuPlanner application Unit, automated payments processing will occur.

The client can update their HealthAnalytics profile including demographic and socio-economic populations the would like to compare their diet metrics with, if they consent to have their diet metrics shared with their Health insurance company and their Health insurance company details on an app or web site page.

The client can update their Outsourced Meal Preferences including preferred Kit meal suppliers (e.g., Home Chef, Blue Apron), Home meal delivery (e.g., Munchery), UberEats, take away, café and restaurants, OpenTable on an app or web site page.

All client information is securely held.

The disclosure of the invention described herein-above represents the preferred embodiment of the invention; however, variations thereof, in the form, construction, and arrangement of the component thereof and the modified application of the invention are possible without departing from the spirit and scope of the appended claim.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A system for providing electronic meal information to a user, the system comprising:
one or more computer readable storage devices configured to store:
a plurality of computer executable instructions;
a recipe database;
a menu planner module;
a personal assistant application comprising an intake module and a shopping module;
wherein the recipe database is configured to store a plurality of recipe objects, each recipe object associated with a recipe metadata object indicating at least:
the name of the recipe;
the serving size of the recipe;
the recipe ingredients; and
a user rating of the recipe;
wherein the intake module is configured to receive unprocessed recipe data from a plurality of sources and convert it to processed recipe data, the sources including:
an optical character recognition module; and
direct download delivery via an application programmable interface;
wherein the intake module is further configured to process the unprocessed recipe data using a machine learning algorithm to generate and store learned recipe data;
wherein the menu planner database is configured to receive and store a plurality of user preferences to generate a menu, the user preferences including:
the time period that the menu will cover;
a style of cuisine to include in the menu;
nutritional requirements for the menu; and
desired ingredients to include in the menu;
one or more hardware computer processors in communication with the one or more computer readable storage devices and configured to execute the plurality of computer executable instructions in order to cause the computer system to automatically:
receive and process unprocessed recipe data in the intake module to generate processed recipe data and learned recipe data;
receive, in the menu planner module, a plurality of user preferences;
generate a menu according to the user preferences, utilizing the recipe metadata objects, processed recipe data, and learned recipe data;
transfer the menu to the shopping module to generate a shopping list;
receive, in the recipe planner application, at least one performance characteristic indicative of the user's experience with at least one recipe in the menu, associate the performance characteristic with the recipe, and store in the database.

2. The system of claim 1 wherein the plurality of computer executable instructions further causes the computer system to automatically generate a shopping list comprising recipe ingredients in the menu.

3. The system of claim 1 wherein a plurality of computer executable instructions further causes the computer system to automatically generate a shopping list comprising recipe ingredients in the menu that excludes items in the user's pantry.

4. The system of claim 3 wherein the items in the user's pantry are identified using an analytics module.

5. The system of claim 1 wherein a plurality of computer executable instructions further causes the computer system to automatically generate nutrition data concerning the menu.

6. The system of claim 1 wherein the performance characteristic is one of: star rating, desired frequency, ingredient changes, and method changes.

7. The system of claim 1 wherein the learned recipe data includes one of: dietary style, allergy considerations, calorie information, and nutrition information.

8. A method for providing electronic meal information to a user, the method comprising:
generating a recipe database is configured to store a plurality of recipe objects, each recipe object associated with a recipe metadata object indicating at least:
the name of the recipe;
the serving size of the recipe;
the recipe ingredients; and
a user rating of the recipe;
wherein the recipe database is configured to receive and store a plurality of user preferences to generate a menu, the user preferences including:
the time period that the menu will cover;
a style of cuisine to include in the menu;
nutritional requirements for the menu; and
desired ingredients to include in the menu;
receiving unprocessed recipe data in an intake module to generate processed recipe data and learned recipe data, the intake module configured to receive unprocessed recipe data from a plurality of sources including:
an optical character recognition module; and
direct download delivery via an application programmable interface;
processing unprocessed recipe data using a machine learning algorithm to generate and store learned recipe data;
receiving, in a menu planner module, a plurality of user preferences;
generating a menu according to the user preferences, utilizing the recipe metadata objects, processed recipe data, and learned recipe data;
transferring the menu to the shopping module to generate a shopping list; and
receiving, in the recipe planner application, at least one performance characteristic indicative of the user's experience with at least one recipe in the menu, associate the performance characteristic with the recipe, and store in the database.

9. The method of claim 8 further including the step of automatically generate a shopping list comprising recipe ingredients in the menu.

10. The method of claim 8 further including the step of automatically generate a shopping list comprising recipe ingredients in the menu that excludes items in the user's pantry.

11. The method of claim 10 wherein the items in the user's pantry are identified using an analytics module.

12. The method of claim 8 further including the step of automatically generating nutrition data concerning the menu.

13. The method of claim 8 wherein the performance characteristic is one of: star rating, desired frequency, ingredient changes, and method changes.

14. The method of claim 8 wherein the learned recipe data includes one of: dietary style, allergy considerations, calorie information, and nutrition information.
